(19) United States
(12) Patent Application Publication
(10) Pub. No.: US 2013/0088523 A1
(43) Pub. Date: Apr. 11, 2013

(54) ELECTRONIC DEVICE WITH FUNCTION OF ADJUSTING DISPLAY BRIGHTNESS AND METHOD THEREFOR

(71) Applicant: CHING-CHUNG WU, Tu-Cheng (TW)

(72) Inventor: CHING-CHUNG WU, Tu-Cheng (TW)

(73) Assignee: HON HAI PRECISION INDUSTRY CO., LTD., Tu-Cheng (TW)

(21) Appl. No.: 13/300,675

(22) Filed: Nov. 21, 2011

(30) Foreign Application Priority Data
Oct. 11, 2011 (TW) 100136685

(51) Int. Cl. G09G 5/10

(52) U.S. Cl. 345/690

(57) ABSTRACT

A device and a method for adjusting display brightness employed in a display are provided. Two light sensors are mounted in the electronic device in different locations and the two light sensors are configured to sense levels of ambient light at those different locations. A control unit of the electronic device constantly monitors the two light sensors to determine whether any adjustment of the brightness of the display unit is required, so as to present an appropriate display mode at all times.

### BACKGROUND

1. Technical Field

The disclosure relates to electronic devices and, more particularly, to an electronic device capable of adjusting display brightness and a method for adjusting display brightness adapted for the electronic device.

2. Description of Related Art

The brightness of an LCD panel in a variety of electronic devices, such as mobile phones, digital cameras, and other devices, can be adjusted by detecting ambient brightness with a detector, and thereby the brightness of the display can be balanced against the ambient level of light. However, when the light detector is covered by an object, such as the fingers or face of a user, or other objects, the backlight of the device will be adjusted to become low. The device cannot distinguish between generally low ambient light and a decrease in light due to the unintentional covering of the detector by objects around the device.

Therefore, what is needed is an electronic device to overcome the described shortcomings.

### BRIEF DESCRIPTION OF THE DRAWINGS

FIG. 1 is a block diagram of an electronic device, in accordance with an exemplary embodiment.

FIG. 2 is a flowchart of a method for adjusting display brightness employed by the electronic device of FIG. 1.

### DETAILED DESCRIPTION

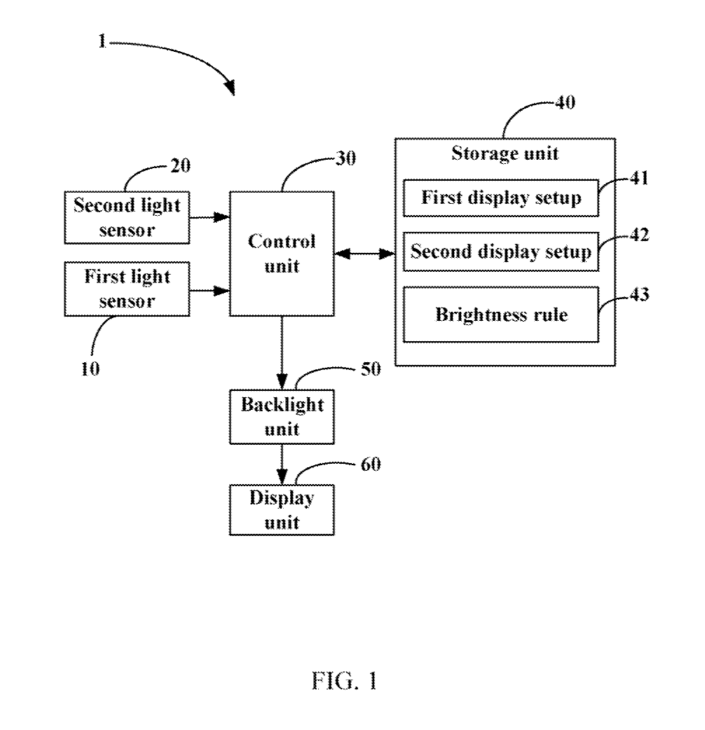

FIG. 1 is a block diagram of an electronic device, in accordance with an exemplary embodiment. The electronic device 1 defines a normal display mode and a dark display mode. The device 1 includes a first light sensor 10, a second light sensor 20, a control unit 30, a storage unit 40, a backlight unit 50, and a display unit 60. The backlight unit 50 backlights the display unit 60. The display unit 60 displays information. The control unit 30 controls the electronic device 1.

The two light sensors 10, 20 are positioned on different locations in the electronic device 1 and sense and register a level of ambient light at different locations in real time. In the embodiment, the first light sensor 10 senses the level of ambient light in front of the electronic device 1, the second light sensor 20 senses the level of ambient light at back of the electronic device 1 or on one side of the electronic device 1.

The storage unit 40 stores a first display setup 41 associated with the normal display mode, a second display setup 42 associated with the dark display mode, and a brightness rule 43 for switching between the normal display mode and the dark display mode according to ambient light. Each of the first and second display setups 41 and 42 records a number of display parameters. The display parameters include, but are not limited to, a brightness of the display unit 60, a background color, and a font color on the display unit 60.

The first display setup 41 includes a first brightness, a first preset background color, and a first preset font color associated with the normal display mode. For example, the display on the display unit 60 is based on the first preset brightness, the background color is set in a medium shade, and the font color on the display unit 60 is not arresting or eye-catching. The second display setup 42 includes a second brightness, a second preset background color, and a second preset font color associated with the dark display mode. For example, the display on the display unit 60 is based on a low ambient brightness, the background color on the display unit 60 is set in a darker shade, and the font color on the display unit 60 is set in a lighter color to provide a better contrast against the background color.

The brightness rule 43 defines relationships between the levels of ambient light sensed by the light sensors 10, 20 and the two display modes. For example, when the ambient brightness sensed by any one of the two light sensors 10, 20 is greater than a first preset value, the brightness rule 43 will maintain the brightness of the display unit 60; when the ambient brightness sensed by both of the two light sensors 10, 20 is less than the first preset value, the brightness rule 43 will provide instruction for the control unit 30 to switch the display unit 60 from the normal display mode to the dark display mode.

In another embodiment, when the ambient brightness sensed by the first light sensor 10 is greater than a second preset value and the ambient brightness sensed by the second light sensor 20 is less than a third preset value, or if the ambient brightness sensed by the first light sensor 10 is less than the second preset value and the ambient brightness sensed by the second light sensor 20 is greater than the third preset value, the brightness rule 43 will maintain the brightness of the display unit 60; and when both of the light sensors 10, 20 detect ambient brightness at less than the second and the third preset values, the brightness rule 43 will provide instruction for the control unit 30 to switch the display unit 60 from the normal display mode to the dark display mode.

The control unit 30 records the level of ambient light sensed by each of the first and the second light sensors 10, 20 when the display unit 60 is in the normal display mode, and controls the mode of display on the display unit 60 according to the brightness rule 43. The control unit 30 further decreases the brightness of the backlight unit 50 based on the second display setup 42 to achieve the dark display mode. In another embodiment, in the dark display mode, the control unit 30 further adjusts the background color and the font color on the display unit 60 based on the second display setup 42.

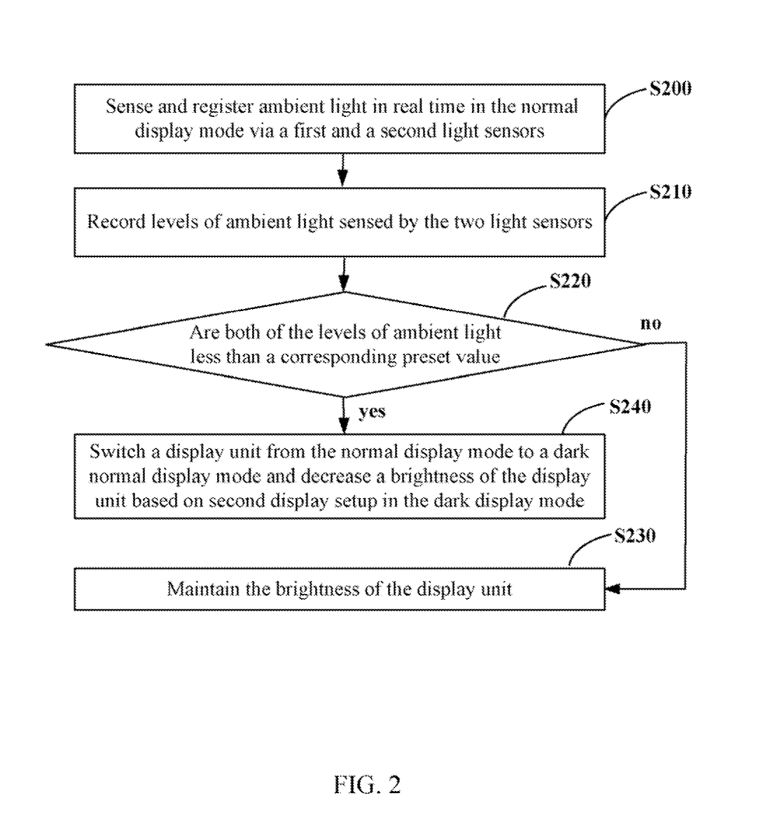

FIG. 2 is a flowchart of a method for adjusting display brightness employed by the electronic device of FIG. 1. In step S200, each of the first and the second light sensors 10, 20 senses and registers the level of ambient light in real time when the display unit 60 is in the normal display mode. In step S210, the control unit 30 records the ambient light levels registered by the first and the second light sensors 10, 20. In step S220, the control unit 30 determines whether the levels of ambient light sensed by both of the first and the second light sensors 10, 20 are less than the corresponding preset value according to the brightness rule 43. If the level of ambient light sensed by any one of the first and the second light sensors 10, 20 is greater than the corresponding preset value, in step S230, the control unit 30 maintains the brightness of the display unit 60 in accordance with the normal display mode.

If both of the first and the second light sensors 10, 20 sense the levels of ambient light which are less than the corresponding preset value, in step S230, the control unit 30 switches the display unit 60 from the normal display mode to the dark display mode and controls the backlight unit 50 to decrease the brightness of the display unit 60 based on the second display setup 42. In another embodiment, in the dark display mode, the control unit 30 adjusts the background color and the font color on the display unit 60 based on the second display setup 42.

Two light sensors 10, 20 are mounted in the electronic device 1 in different locations and the two light sensors 10, 20 are configured to sense the levels of ambient light at those different locations. The control unit 30 constantly monitors the two light sensors 10, 20, to determine whether any adjustment of the brightness of the display unit 60 is required, so as to present an appropriate display mode at all times.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a display unit;
a backlight unit to backlight the display unit;
a first light sensor to sense and register a level of ambient light in front of the electronic device in real time;
a second light sensor to sense and register a level of ambient light at back of the electronic device or on one side of the electronic device in real time;
a storage unit to store a first display setup associated with a normal display mode, a second display setup associated with a dark display mode, and a brightness rule for switching between the normal display mode and the dark display mode according to ambient light, wherein each of the first and the second display setups records a brightness of the display unit; and
a control unit, to record the levels of ambient light of the first and the second light sensors in the normal display mode, to maintain the brightness of the display unit or switch the display unit from the normal display mode to the dark normal display mode according to the brightness rule, and to control the backlight unit to decrease the brightness of the display unit based on the second display setup in the dark display mode.

2. The electronic device as recited in claim 1, wherein each of the first and the second display setups further records a background color and a font color on the display unit, the control unit is further configured to adjust the background color and the font color on the display unit based on the second display setup in the dark display mode.

3. The electronic device as recited in claim 1, wherein the brightness rule records relationships between the levels of ambient light sensed by the first and the second light sensors and the normal and the dark display modes.

4. The electronic device as recited in claim 3, wherein when the level of ambient light sensed by any one of the first and the second light sensors is greater than a first preset value, the brightness rule will maintain the brightness of the display unit; when both of the levels of ambient light sensed by the first and the second light sensors are less than the first preset value, the brightness rule will provide instruction for the control unit to switch the display unit from the normal display mode to the dark normal display mode.

5. The electronic device as recited in claim 3, wherein when the level of ambient light sensed by the first light sensor is greater than a first preset value and the level of ambient light sensed by the second light sensor is less than a second preset value, or the level of ambient light sensed by the first light sensor is less than the first preset value and the level of ambient light sensed by the second light sensor is greater than the second preset value, the brightness rule will maintain the brightness of the display unit; and when both the levels of ambient light sensed by the first and the second light sensors are respectively less than the first and the second preset values, the brightness rule will provide instruction for the control unit to switch the display unit from the normal display mode to the dark normal display mode.

6. A method for adjusting display brightness for an electronic device, wherein the device comprises a display unit, a first light sensor sensing a level of ambient light in front of the device, and a second light sensor sensing a level of ambient light at back or on one side of the device, and the device stores a first display setup associated with a normal display mode and a second display setup associated with a dark display mode, each of the first and the second display setups records a brightness of the display unit, the method comprising:
sensing and registering levels of ambient light in real time in the normal display mode via the first and the second light sensors;
recording the levels of ambient light sensed by the first and the second light sensors;
determining whether both of the levels of ambient light sensed by the first and the second light sensors are less than a corresponding preset value;
if the level of ambient light sensed by any one of the first and the second light sensors is greater than the corresponding preset value, maintaining the brightness of the display unit; and
if both of the levels of ambient light sensed by the first and the second light sensors are less than the corresponding preset value, switching the display unit from the normal display mode to the dark normal display mode and decreasing the brightness of the display unit based on the second display setup in the dark display mode.

7. The method for adjusting brightness as recited in claim 6, wherein each of the first and the second display setups further records a background color and a font color on the display unit, the method further comprising:
adjusting the background color and the font color on the display unit based on the second display setup in the dark display mode.
